(19) United States
(12) Patent Application Publication
(10) Pub. No.: US 2025/0010526 A1
(43) Pub. Date: Jan. 9, 2025

(54) RECORDING APPARATUS AND RECORDING METHOD

(71) Applicant: CANON KABUSHIKI KAISHA, Tokyo (JP)

(72) Inventors: TOMOKAZU ISHIKAWA, Kanagawa (JP); FUMITAKA GOTO, Tokyo (JP); YUTA IKESHIMA, Kanagawa (JP); TAKAHISA AKAISHI, Kanagawa (JP)

(21) Appl. No.: 18/758,354

(22) Filed: Jun. 28, 2024

(30) Foreign Application Priority Data
Jul. 3, 2023 (JP) 2023-109639

(51) Int. Cl. B29C 44/60; B29C 44/02; B33Y 50/02

(52) U.S. Cl. CPC B29C 44/60; B29C 44/022; B33Y 50/02

(57) ABSTRACT

A recording apparatus controls a color difference caused by a degree of foaming of foaming particles in a case of forming a recording product including a convex structure that is formed by causing the foaming particles to foam, by determining application amounts of colored liquids so that a larger amount is applied to a region that is caused to foam in a larger degree even when the colored liquids indicate the same color.

### BACKGROUND

### Field

The present disclosure relates to a recording apparatus for recording an image on a recording medium, and a recording method therefor.

### Description of the Related Art

Conventionally, there is known a method of forming a concavo-convex structure in a recording apparatus for forming a three-dimensional (3D) image by applying a foaming control liquid on a surface of a foamable sheet and applying heat or irradiating the surface with an electromagnetic wave.

Japanese Patent Application Laid-open No. 2019-188774 discusses a technique of forming a concavo-convex structure by applying a foaming acceleration liquid for accelerating foaming onto a surface of a foamable sheet, and then irradiating the surface with an electromagnetic wave. The foaming acceleration liquid includes a material absorbing heat of the electromagnetic wave, and not a colorless liquid but a colored liquid is used as the foaming acceleration liquid. To solve an issue that a region with the foaming acceleration liquid applied thereon and a region with no foaming acceleration liquid applied thereon have different colors, Japanese Patent Application Laid-open No. 2019-188774 discusses a technique of reducing the color difference by forming a color adjustment layer on the region with no foaming acceleration liquid applied thereon.

### SUMMARY

According to an aspect of the present disclosure, a recording apparatus includes one or more memories storing instructions, and one or more processors that, upon execution of the stored instructions, are configured to apply a foaming control liquid for controlling a foaming degree of a foaming particle and a colored liquid containing a color material onto a recording medium in which a foam layer containing the foaming particle that foams by application of energy is provided on a base material, generate a recording signal value for the colored liquid indicating an amount of the colored liquid to be applied onto the recording medium based on data of the colored liquid, and a recording signal value of the foaming control liquid indicating an amount of the foaming control liquid to be applied onto the recording medium based on data of the foaming control liquid, and control an application operation of the application unit based on the generated recording signal value of the colored liquid and the recording signal value of the foaming control liquid, wherein, in a case where the data of the colored liquid indicates that a color of a first region and a color of a second region are a same color, and where the data of the foaming control liquid indicates a degree of causing the first region to foam is larger than a degree of causing the second region to foam, the recording signal value of the colored liquid are generated so that an application amount of the colored liquid on the first region is larger than an application amount of the colored liquid on the second region.

Further features of the present disclosure will become apparent from the following description of exemplary embodiments with reference to the attached drawings.

### BRIEF DESCRIPTION OF THE DRAWINGS

FIG. 1 is a diagram illustrating a recording medium on which a three-dimensional image is to be formed according to a first exemplary embodiment.

FIG. 2 is a diagram illustrating a cross-section configuration of a recording apparatus according to the first exemplary embodiment.

FIG. 3 is a diagram illustrating an example of a configuration of a recording head according to the first exemplary embodiment.

FIGS. 4A and 4B are diagrams each illustrating an example of an input image according to the first exemplary embodiment.

FIG. 5 is a block diagram illustrating an example of a system configuration according to the first exemplary embodiment.

FIG. 6 is a sequence diagram illustrating a sequence of a recording (print) service according to the first exemplary embodiment.

FIG. 7 is a flowchart illustrating a procedure of image recording processing according to the first exemplary embodiment.

FIGS. 8A and 8B are diagrams illustrating an edge determination according to the first exemplary embodiment.

FIG. 9 is a flowchart illustrating a procedure of image recording processing according to a second exemplary embodiment.

### DESCRIPTION OF THE EMBODIMENTS

Hereinbelow, with reference to the attached drawings, exemplary embodiments of the present disclosure will be described.

The number of foaming particles that actually foam can be controlled by changing an application amount of a foaming control liquid for controlling a foaming degree, and as a result of controlling the application amount of the foaming control liquid, the height and the surface area of a convex structure to be formed on a recording medium can be changed during the formation of the convex structure on the recording medium.

On the other hand, an optional color can be given to a region in which the foaming particles are to be caused to foam by applying a colored liquid on the recording medium, in addition to the foaming control liquid for causing the foaming particles to foam. However, there is an issue that, even if the same amount of a colored liquid is applied to each unit area in order to record an evenly colored image, the image on the recording medium will end up being unevenly colored due to the differences of the height and surface area in the above-described convex structure.

To address such an issue, the present disclosure is directed to a technique of preventing the color difference caused by the foaming degree, when a recording product including a convex structure is formed by causing the foaming particles to foam.

### <Recording Medium>

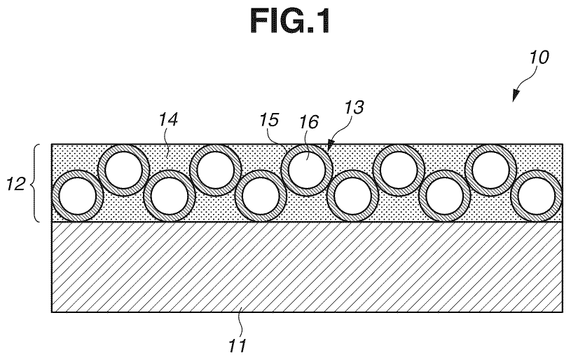

FIG. 1 is a cross-section diagram schematically illustrating a recording medium used in generating a recording product including a three-dimensional (3D) image (convex structure) according to a first exemplary embodiment of the present disclosure. A recording medium 10 includes a base material 11 and a foam layer 12 provided on the base material 11. The foam layer 12 contains foaming particles 13 that foam when heated. Details of the recording medium 10 used in the present exemplary embodiment will be described below.

The base material 11 functions as a support member to support the foam layer 12. The type of the base material 11 is not limited to a certain type. For example, paper produced using normal natural pulp, kenaf paper, a film sheet made of plastic, such as polypropylen, polyethylene, and polyester, and so-called synthetic paper or unwoven fabric, which can be obtained by making their physical characteristics the same as those of paper using synthetic fabric, synthetic pulp, or a synthetic resin film may be used.

The foam layer 12 is provided at least on one surface of the base material 11, and contains the foaming particles 13 and binder resin 14. Each of the foaming particles 13 is a thermally expandable micro capsule including a capsule shaped shell layer 15 containing thermoplastic resin, and a volatile material 16 enclosed in the shell layer 15. When heat is applied to each of the foaming particles 13, the thermoplastic resin contained in the shell layer 15 becomes soft. At the same time, the volume of each of the foaming particles 13 expands due to vaporization of the volatile material 16 enclosed in the shell layer 15, which causes each of the foaming particles 13 to be swollen up like a balloon.

Examples of the thermoplastic resin contained in the shell layer 15 include polystyrene, styrene-acrylic acid ester copolymer, polyamide resin, polyacrylic acid ester, polyvinylidene chloride, polyacrylonitrile, polymethyl methacrylate, vinylidene chloride-acrylonitrile, methacrylic acid ester-acrylic acid copolymer, vinylidene chloride-acrylic acid copolymer, and vinylidene chloride-acrylic acid ester copolymer.

Examples of the volatile material 16 include low-molecular-weight hydrocarbon, such as ethane, ethylene, propane, propene, n-butane, isobutane, n-pentane, isopentane, neopentane, n-hexane, heptane, and petroleum ether, chlorofluorocarbon such as CCI3F, CCI2F2, CCIF3, and CCIF2-CCIF2, and tetraalkylsilane, such as tetramethylsilane, trimethylethylsilane, trimethylisopropylsilane, and trimethyl-n-propylsilane. The volatile material 16 is desirably hydrocarbon having a molecular weight of 120 or less. There is no lower limit for the molecular weight of the volatile material (hydrocarbon), but it is desirably 50 or more. The content of the foaming particles 13 in the foam layer 12 is desirably 5 mass % or more and 95 mass % or less, based on the total mass of the foam layer 12.

The foam layer 12 contains the binder resin 14 to increase the adhesiveness with the base material 11. The binder resin 14 plays an important role to prevent the foam layer 12 from peeling off of the base material 11 when the foaming particles 13 foam by being heated. As the binder resin 14, water-insoluble resin is used. Since the water-insoluble resin is not easily dissolved by water contained in a foaming acceleration liquid, the adhesiveness between the foam layer 12 and the base material 11 can be maintained even in a case where the foaming acceleration liquid is applied. Further, for the same reason, the adhesiveness between the foam layer 12 and the base material 11 can be maintained even in a case where an aqueous ink containing water is applied on the recording medium 10.

The water-insoluble resin refers to a resin that remains in the amount 95% by mass or more after the resin is immersed in warm water of 80° C. for two hours. In addition, the water-insoluble resin is desirably at least one type selected from a group consisting of acrylic resins and urethane resins. Further, the water-insoluble resin is more desirably at least one type selected from a group consisting of acrylic resins not containing an ester group, and urethane resins not containing an ester group. Furthermore, it is desirable to employ a resin with no water-absorbing property. The content of the water-insoluble resin in the foam layer 12 is desirably 10 mass % or more and 95 mass % or less based on the total mass of the foam layer 12.

The foam layer 12 may contain water-soluble resin in addition to the water-insoluble resin, within the range in which the effect of the present exemplary embodiment can be obtained. Further, the glass transition temperature of the binder resin 14 is desirably −10° C. or higher and 30° C. or lower. By setting the glass transition temperature of the binder resin 14 within the foregoing range, it is possible to prevent the binder resin 14 from interfering with the foaming of the foaming particles 13.

The mass ratio of the foaming particles 13 to the binder resin 14 is desirably 5:95 to 90:10 (the foaming particles 13: the binder resin 14=5:95 to 90:10). By setting the mass ratio of the foaming particles 13 to the binder resin 14 within this range, the foamability of the foaming particles 13 and the binding property of the binder resin 14 to the base material 11 can both be improved. The foam layer 12 may further contain components such as pigment, antioxidant, dye, and a surface activating agent, within a range not damaging the foamability.

### <Foaming Acceleration Liquid and Foaming Suppression Liquid>

Examples of the foaming control liquid for controlling the degree of foaming of the foaming particles 13 include a foaming acceleration liquid for accelerating the foaming and a foaming suppression liquid for suppressing the foaming. In the present exemplary embodiment, a foaming acceleration liquid containing a foaming acceleration component that lowers the temperature where the foaming particles 13 start to foam is used. When the foaming acceleration liquid is applied to the foam layer 12 of the recording medium 10 using a method of discharging the foaming acceleration liquid by an inkjet method, or applying the foaming acceleration liquid by a roller, the thermoplastic resin of the shell layer 15 is softened. It is assumed that, as a result, the temperature where the foaming particles 13 start foaming can be shifted to a lower temperature side.

The foaming acceleration component just needs to be a compound that can soften the thermoplastic resin contained in the shell layer 15 and contains no hydroxyl group, and the foaming acceleration component is appropriately selected and used depending on the type of the thermoplastic resin. Examples of the foaming acceleration component include 2-pyrolidone, dimethyl sulfoxide, nitrogen (N), N-dimethylformamide, and N-methyl-2-pyrolidone. The boiling temperature of the compound that does not contain a hydroxyl group and serves as a foaming acceleration component is desirably higher than the temperature at which the foam layer 12 is heated. In a case where the boiling temperature of the foaming acceleration component is higher than the temperature at which the foam layer 12 is heated, the foaming acceleration component is not vaporized even if the foam layer 12 is heated, which contributes to the softening of the thermoplastic resin of the shell layer 15. The content of the foaming acceleration component is desirably 10 mass % or more and 70 mass % or less, based on the total mass of the foaming acceleration liquid.

The absolute value of the difference (|SP1−SP2|) between a solubility parameter (SP1) of the thermoplastic resin of the shell layer 15 and a solubility parameter (SP2) of the foaming acceleration component is desirably 3.5 or less. When the absolute value of the difference between the solubility parameters is within the above-described range, it is possible to further improve the foamability in the region to which the foaming acceleration liquid is applied.

Further, the absolute value of the difference (|HSP1−HSP2|) between a Hansen solubility parameter (HSP1) of the thermoplastic resin of the shell layer 15 and a Hansen solubility parameter (HSP2) of the foaming acceleration component is desirably 20 or less. When the absolute value of the difference between the Hansen solubility parameters is within the above-described range, the foamability in the region to which the foaming acceleration liquid is applied can be further improved.

The solubility parameters (SP values) of the thermoplastic resin of the shell layer 15 and the foaming acceleration component are both calculable values. Further, the Hansen solubility parameters (HSP values) of the thermoplastic resin of the shell layer 15 and the foaming acceleration component are both measurable and calculable values using a dynamic light scattering method.

In addition, in a case where the foaming acceleration component is liquid at normal temperature (25° C.), the foaming acceleration component itself may be used as the foaming acceleration liquid. Further, the foaming acceleration liquid may further contain other components in addition to the foaming acceleration component. For example, the foaming acceleration liquid may contain a liquid component for increasing the discharging stability of the foaming acceleration liquid, such as a solvent. As the solvent, water and various kinds of water-soluble organic solvents are used.

As the water, deionized water (ion-exchanged water) is desirably used. Examples of the water-soluble organic solvent include alcohols, glycols, glycol ethers, and nitrogen-containing compounds.

For components other than the liquid components, water-soluble organic compounds that are solid at temperature 25° C., such as urea or its derivatives, trimethylolpropane, and trimethylolethane, are used. Further, the foaming acceleration liquid may contain, if needed, various kinds of additive agents, such as a pH adjusting agent, an antifoaming agent, an antirust agent, an antiseptic agent, an antimold agent, an antioxidizing agent, a reducing inhibitor, and a chelate agent.

### <Recording Apparatus for Forming 3D Image>

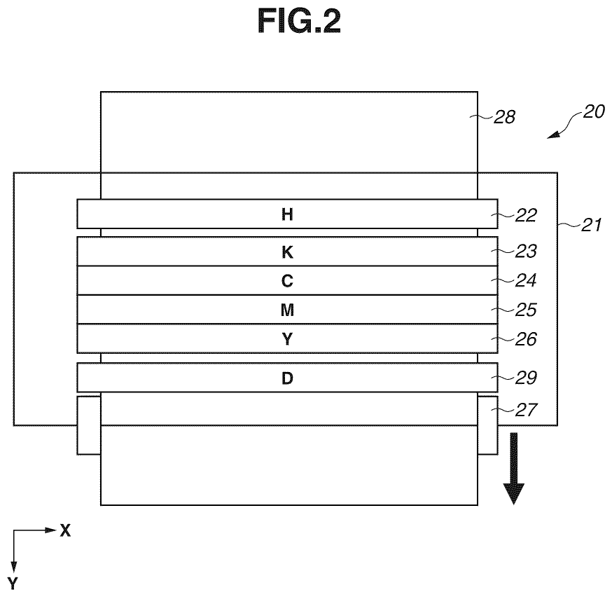

FIG. 2 is a schematic diagram illustrating a configuration of a recording apparatus 20 used in the present exemplary embodiment. The recording apparatus 20 according to the present exemplary embodiment is a full line type inkjet recording apparatus. In the recording apparatus 20, a recording head 21 having a width equivalent to the width of the recording medium 10 and a heating device 29 including a heating unit are arranged in parallel in a Y direction. The recording head 21 includes a recording element array 22 in which a plurality of recording elements for discharging a foaming acceleration liquid (H) as liquid droplets is arranged. Further, the recording head 21 includes the total of four recording element arrays 23 to 26. Each of the four element arrays 23 to 26 includes a plurality of recording elements that discharges as droplets one of black (B), cyan (C), magenta (M), and yellow (Y) inks, which are colored inks including respectively different color materials. The recording element arrays 22 to 26 are arranged in parallel along a conveyance direction (Y direction in FIG. 2) in which the recording medium 10 is conveyed. The recording element array 22 that discharges the foaming acceleration liquid may be positioned either upstream or downstream of the recording element arrays 23 to 26, which discharge respectively different color liquids, in the conveyance direction. The foaming acceleration liquid discharged by the recording element array 22 is applied to the foam layer 12 on the recording medium 10. The heating device 29 is arranged downstream of the recording element array 22 to 26 in the conveyance direction. Any heating method can be used for the heating device 29 as long as the heating device 29 can heat the foaming particles 13 in the foam layer 12 to a desired temperature. For example, a dryer, an oven, a heater, and a heating iron can be used.

Applying operations of applying the foaming acceleration liquid and the colored liquids onto the recording medium 10 may also be referred to as recording processing. After applying the foaming acceleration liquid containing the foaming acceleration component onto the recording medium 10 including the foam layer 12, the foam layer 12 of the recording medium 10 is heated. The foaming particles 13 to which the foaming acceleration liquid is applied expand and foam by being heated, and a 3D image, which expresses a clear convex structure, is formed on the recording medium 10. With the rotation of a conveyance roller 27, the recording medium 10 is conveyed at a predetermined speed in the conveyance direction, and recording processing by the recording head 21 and heating processing by the heating device 29 are performed thereon. At positions at which the recording processing and the heating processing are performed, the recording medium 10 is supported from below by a platen 28 made of a flat plate. In this way, the distance of the recording medium 10 from the recording head 21 or the heating device 29 is fixed, and the smoothness of the recording medium 10 is maintained.

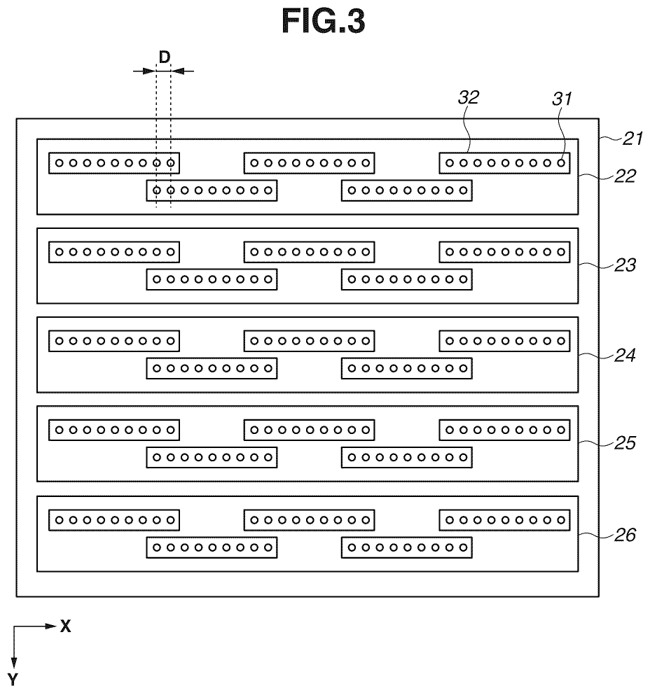

FIG. 3 is a schematic diagram illustrating a configuration of the recording head 21. In the recording head 21, each of the recording element arrays 22 to 26 includes a plurality of recording element substrates 32. The recording element substrates 32 are arranged continuously in an X direction and alternately in the Y direction such that the adjacent recording element substrates 32 partially overlap in an overlap region D. On each of the recording element substrates 32, a plurality of recording elements 31 is arranged at constant pitches. Ink droplets are discharged from the recording elements 31 at a constant frequency according to recording data onto the recording medium 10 conveyed at a constant speed in the Y direction, and an image is recorded on the recording medium 10 at a resolution corresponding to the arrangement pitches of the recording elements 31.

### <Input Image>

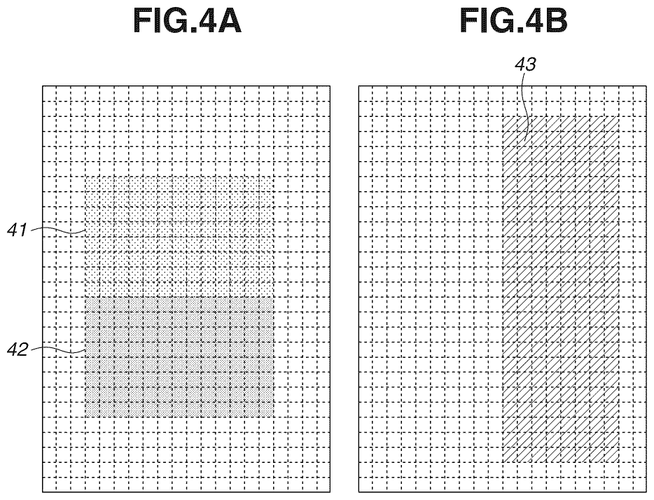

FIGS. 4A and 4B are diagrams each illustrating an example of an image that can be input to the recording apparatus 20 according to the present exemplary embodiment. The input image consists of a colored liquid plate, which is data used for applying colored liquids, and a foam plate, which is data used for applying a foaming liquid. The squares divided by the dotted lines in FIGS. 4A and 4B indicate individual pixels.

FIG. 4A illustrates an example of the foaming plate. The shades of black and white in the foaming plate indicate regions to be foamed and expanded, and the degrees of the expansion for the respective regions in the recording medium 10. The foaming plate according to the present exemplary embodiment is gray data with information of one color of 8 bits, and the value range thereof is 0 to 255. However, the number of bits is not limited thereto, and may be 16 bits or the like. In the foaming plate, the high-density region indicates a part to be expanded in the recording medium 10. Further, it indicates that the higher the density of the pixel is (i.e., the lower the luminance is), the larger the degree of expansion is, and the lower the density of the pixel is (i.e., the higher the luminance is), the smaller the degree of expansion is. A region 41 has a density M, and a region 42 has a density N, and the density M is less than the density N (M<N). The region 42 is higher in density, and larger in expansion degree. The larger the degree of the expansion is, the greater the height of the convex structure is, and the smaller the degree of the expansion is, the smaller the height of the convex structure is.

As described above, in the foaming plate, the shading pattern is depicted so that the region to be expanded in a larger degree has a higher density. In this way, the 3D structure with a desired height can be formed on the recording medium 10, depending on the value of each pixel.

FIG. 4B illustrates an example of the colored liquid plate corresponding to the colored liquids. The shades of black and white in the colored liquid plate indicates colors for coloring regions in the recording medium 10. The colored liquid plate according to the present exemplary embodiment is red, green, and blue (RGB) data, and examples of its type include standard color information such as sRGB and Adobe®RGB. In the present exemplary embodiment, the image data has 8 bit information and a value range of 0 to 255 for each color. However, the number of bits is not limited thereto, and may be 16 bits or the like. In a case where the input image is generated using Portable Document Format (PDF) or the like, the foaming plate in FIG. 4A and the colored liquid plate in FIG. 4B need to be generated as different layers.

### <System Configuration>

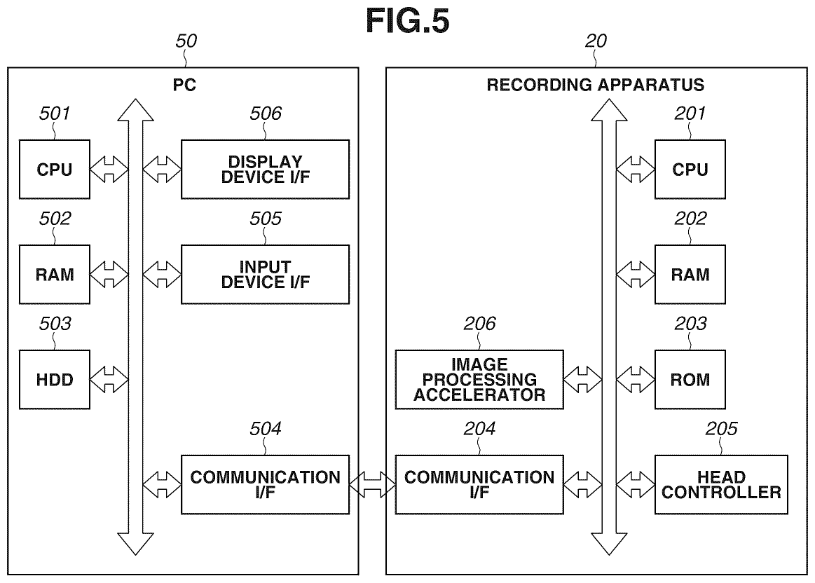

FIG. 5 is a block diagram illustrating an entire configuration of a system according to the present exemplary embodiment. The system according to the present exemplary embodiment includes the recording apparatus 20 illustrated in FIG. 2, and a personal computer (PC) 50 serving as a host apparatus of the recording apparatus 20.

The PC 50 includes a central processing unit (CPU) 501, a random access memory (RAM) 502, and a hard disk drive (HDD) 503. Further, the PC 50 includes a communication interface (I/F) 504, an input device I/F 505, and a display device I/F 506, which are communicably connected with each other via an internal bus.

The CPU 501 executes processing according to programs and various kinds of data stored in the HDD 503 or the RAM 502. The RAM 502 is a volatile storage for temporarily storing programs and data. The HDD 503 is a nonvolatile storage for storing programs and data.

The communication I/F 504 is an interface that controls communication with external apparatuses, and in the present exemplary embodiment, the communication I/F 504 controls data transmission and reception with the recording apparatus 20. As a connection method for the data transmission and reception, a wired connection, such as a universal serial bus (USB) connection, an Institute of Electrical and Electronics Engineers (IEEE) 1394 connection, and a local area network (LAN) connection, or a wireless connection, such as a Bluetooth® connection, and a WiFi® connection. The input device I/F 505 is an interface for controlling a human interface device (HID), such as a keyboard and a mouse, and receives an input from a user via an input device. The display device I/F 506 controls display of a display device (not illustrated) such as a display.

The recording apparatus 20 includes a CPU 201, a RAM 202, a ROM 203, a communication I/F 204, a head controller 205, and an image processing accelerator 206, which are communicably connected with each other via an internal bus.

The CPU 201 executes processing described below according to programs and various kinds of data stored in the ROM 203 or the RAM 202. The RAM 202 is a volatile storage for temporarily storing programs and data. The ROM 203 is a nonvolatile storage for storing programs used for processing described below and a plurality of pieces of data for look-up tables.

The communication I/F 204 is an interface that controls communication with external apparatuses, and in the present exemplary embodiment, the communication I/F 204 controls data transmission and reception with the PC 50. The head controller 205 controls the recording operation of the recording head 21 illustrated in FIG. 2 based on recording data. More specifically, the head controller 205 is configured to read control parameters and head recording data from predetermined addresses in the RAM 202. When the CPU 201 writes the control parameters and the head recording data to predetermined addresses of the RAM 202, the head controller 205 starts the processing, and the foaming acceleration liquid and the colored liquids are discharged from the recording elements 31 of the recording head 21. The image processing accelerator 206 is configured with hardware, and can perform image processing faster than the CPU 201. More specifically, the image processing accelerator 206 reads parameters and data required for the image processing from predetermined addresses of the RAM 202. When the CPU 201 writes the parameters and the data at predetermined addresses in the RAM 202, the image processing accelerator 206 is activated to start performing predetermined image processing. However, the image processing accelerator 206 is not necessarily an essential device, and the processing of generating table parameters and the image processing described above may be performed only by the processing of the CPU 201, depending on the specification of the recording apparatus 20.

In the present exemplary embodiment, the description is given assuming that the recording apparatus 20 and the PC 50 are separate apparatuses, but the recording apparatus 20 and the PC 50 may be a system integrally configured of the recording apparatus 20 and the PC 50. Further, the PC 50 is exemplified as the host apparatus, but it is not limited thereto, and a portable terminal, such as a smartphone, a tablet terminal, and an imaging apparatus, may be used.

### <Recording Service>

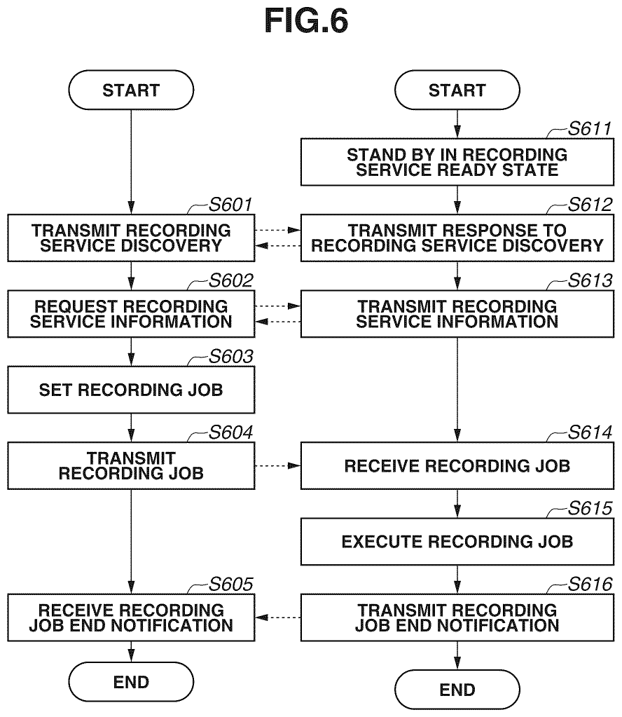

FIG. 6 is a diagram illustrating a sequence executed when a recording (print) service is performed in the system according to the present exemplary embodiment. Processing in steps S601 to S605 is processing performed in the PC 50, and processing in steps S611 to S616 is processing performed in the recording apparatus 20. In FIG. 6, each of dashed arrows indicates data transmission or data reception. Each step is implemented by the CPU 501 of the PC 50 or the CPU 201 of the recording apparatus 20 reading and executing the program stored in the storage unit. This sequence starts in response to power-on of the recording apparatus 20.

In step S611, the recording apparatus 20 confirms that the recording apparatus 20 is in a recordable state after it is powered on, and stands by in a recording service ready state. In step S601, the PC 50 performs a recording service Discovery. The PC 50 may perform the recording service Discovery to search for a peripheral device according to a user's operation, or may perform the recording service Discovery to search periodically for a recording apparatus ready to provide a recording service. Alternatively, when the PC 50 and the recording apparatus 20 are connected, the PC 50 may be configured to issue an inquiry.

In step S612, upon receiving the recording service Discovery from the PC 50, the recording apparatus 20 notifies the PC 50 that the recording apparatus 20 is ready to provide a recording service as a response to the recording service Discovery. In step S602, in a case where the PC 50 is notified by the recording apparatus 20 that the recording apparatus 20 can provide a recording service, the PC 50 requests recording service information from the recording apparatus 20.

In step S613, in response to the recording service information request from the PC 50, the recording apparatus 20 notifies the PC 50 of information about a recording service that the recording apparatus 20 can provide. Upon receiving the recording service information from the recording apparatus 20, in step S603, the PC 50 constructs an interface for generating a recording job, based on the recordable service information. More specifically, based on the recording service information of the recording apparatus 20, the PC 50 displays selection options of, for example, a designation of a recording image, a recording size, and a recordable sheet size, via a display (not illustrated). Then, the PC 50 receives inputs of the settings from a user via an input device (not illustrated), such as a keyboard.

In step S604, the PC 50 issues a recording job based on the settings received from the user, and transmits the recording job to the recording apparatus 20. In step S614, the recording apparatus 20 receives the recording job from the PC 50. In step S615, the recording apparatus 20 analyzes the received recording job, and executes recording processing. The recording processing based on the recording job will be described below.

When the recording processing ends, then in step S616, the recording apparatus 20 notifies the PC 50 that the recording is finished. Then, the processing on the recording apparatus 20 side is completed, and the recording apparatus 20 enters a standby state. In step S605, the PC 50 receives the recording end notification, and notifies the user that the recording has been finished. Then, the processing on the PC 50 side ends.

In the above-described exemplary embodiment, the description is given of an example of communication in which transmission of various kinds of information is requested from the PC 50 to the recording apparatus 20, and the recording apparatus 20 responds to the request. However, it is not limited to the communication example, so-called Pull-type communication, and the communication may be a so-called Push-type communication in which the recording apparatus 20 voluntarily transmits information to one or more PCs 50 present on a network.

### <Processing Flow>

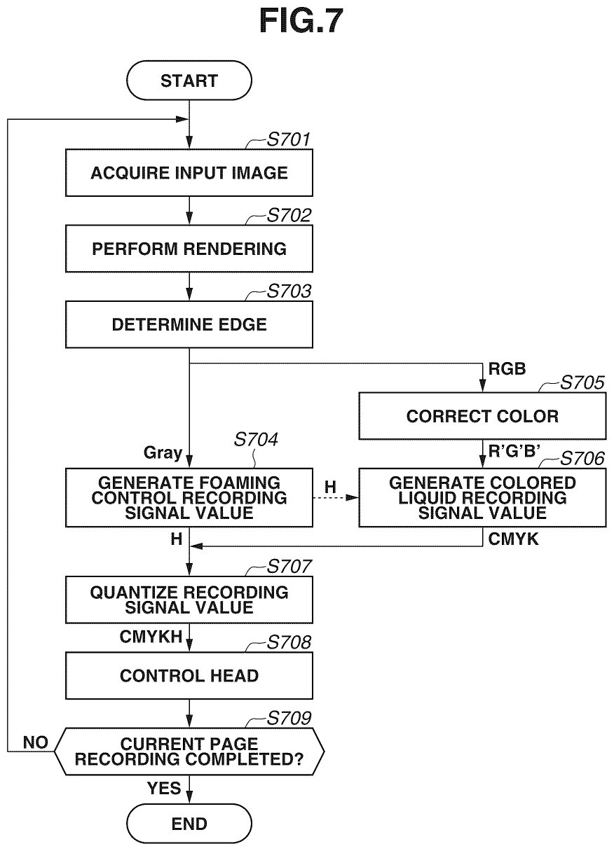

FIG. 7 is a flowchart illustrating a procedure of image processing implementing a density adjustment of each of the regions to which a foaming acceleration liquid (H), and black (K), cyan (C), magenta (M), and yellow (Y) inks are applied, according to the present exemplary embodiment. This flow of processing is implemented when the CPU 201 of the recording apparatus 20 reads and executes the programs and data stored in the ROM 203 in the processing of step S615 in FIG. 6. In addition, the image processing accelerator 206 may execute a part of the flowchart.

In step S701, the CPU 201 acquires an input image (FIGS. 4A and 4B) included in the recording job received in step S614 in FIG. 6. In the flowchart of FIG. 7, the description is given assuming that an input image is acquired for each page. In step S702, the CPU 201 performs rendering processing on the foaming plate and the colored liquid plate in the input image. The rendering resolution is a resolution corresponding to the intervals of the arranged recording elements 31 illustrated in FIG. 3.

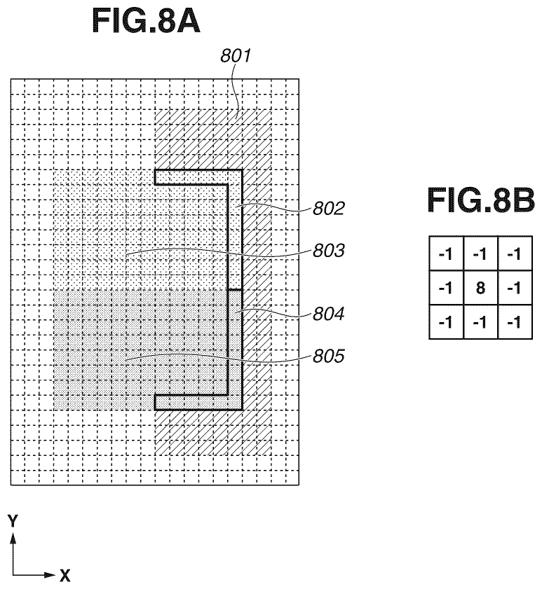

In step S703, the CPU 201 performs an edge determination. In the present exemplary embodiment, the CPU 201 determines, as an edge region, outermost pixels to which the colored liquids are applied in a region to which the foaming acceleration liquid is applied. In addition, the number of pixels to be determined as the edge region may be two or more pixels. In the present exemplary embodiment, FIG. 8A is a diagram illustrating a case where the foaming plate illustrated in FIG. 4A and the colored liquid plate illustrated in FIG. 4B are recorded on the recording medium 10. On the recording medium 10, a part of the region to which the foaming acceleration liquid is applied and a part of the region to which the colored liquids are applied are overlapped. The squares divided by the dotted lines in FIG. 8A indicate individual pixels.

A region 801 is a region to which the colored liquids are applied. A region 802 is an edge region including pixels located outermost in the region having the density M of the foaming acceleration liquid, and overlapping the region 801 to which the colored liquids are applied. Examples of the edge processing method for determining the edge region include a method of performing filter processing (edge enhancement processing) on individual pixels using a Laplacian filter illustrated in FIG. 8B. Alternatively, a known edge detection method may be used. A region 803 is a region detected as a non-edge region consisting of pixels not corresponding to the edge region in the region having the density M of the foaming acceleration liquid.

A region 804 is an edge region including pixels located outermost in the region having the density N of the foaming acceleration liquid, and overlapping the region 801 to which the colored liquids are applied. A region 805 is a non-edge region including pixels not corresponding to the edge region in the region having the density M of the foaming acceleration liquid. The edge determination result is stored in the RAM 202.

In step S704, conversion processing is performed on the foaming plate. The CPU 201 generates a recording signal value for applying the foaming acceleration liquid, based on data represented by the foaming plate. The recording signal value (H) of the foaming acceleration liquid is 8 bit information in which an amount of the foaming acceleration liquid to be applied to each pixel is defined, and the value range thereof is 0 to 255. The value indicating the smallest application amount of the foaming acceleration liquid is “0”, and the value indicating the largest application amount of the foaming acceleration liquid is “255”. The conversion processing in step S704 may be performed using a known method such as matrix arithmetic processing and one dimensional (1D) look-up table processing. With this conversion processing, the recording signal values (H) of the foaming acceleration liquid consisting of one component are generated. In the present exemplary embodiment, an example of the conversion processing using 1D look-up tables as the conversion data will be described.

Equation 1 indicates a function 1D_LUT[Gray] of 1D look-up tables. A variable Gray is a value of each pixel in the foaming plate.

$$H = 1 D\_LUT [ Gray ] \qquad ( Equation 1 )$$

The above described “1D_LUT” consists of 256 data tables. In order to reduce the data amount of the look-up tables, the number of grids may be reduced, for example, from 256 to 64, and interpolation calculation may be performed using 64 data tables to obtain a calculation result. Other than the 64 grids, a suitable number of grids, such as 32 grids or 16 grids, may be set as appropriate. Any known method such as a 1D linear interpolation may be used as the interpolation calculation method.

In the present exemplary embodiment, predefined 1D look-up tables are held in the ROM 203 or the like of the recording apparatus 20.

The processing in steps S705 and S706 is processing to be performed on the colored liquid plate. In step S705, the CPU 201 performs color correction processing based on the data represented by the colored liquid plate. The image data obtained after the color correction processing is RGB data, but at this time point, the image data is assumed to be RGB data dedicated to the recording apparatus 20, so-called device RGB format data. In the color correction processing, a known method, such as matrix arithmetic processing and 3D look-up table processing, is used to perform conversion of the data into device color image data of color signals including three components. In the present exemplary embodiment, an example of the color correction processing using 3D look-up tables as conversion tables will be described.

Equations 2 to 4 are each a function 3D_LUT[R][G][B][N] of the 3D look-up tables. Values of RGB data are respectively input in variables R, G, and B. Any one of R′, G′, and B′ to be output is designated in the variable N. In the present exemplary embodiment, 0, 1, and 2 are respectively designated as the R′, G′, and B′.

$${R}^{′} = 3 D\_LUT [ R ] [ G ] [ B ] [ 0 ] \qquad ( Equation 2 )$$

$${G}^{′} = 3 D\_LUT [ R ] [ G ] [ B ] [ 1 ] \qquad ( Equation 3 )$$

$${B}^{′} = 3 D\_LUT [ R ] [ G ] [ B ] [ 2 ] \qquad ( Equation 4 )$$

The above-described “3D_LUT” is configured of 50,331,648 (=256×256×256×3) data tables. In order to reduce the data amount of the look-up tables, the number of grids may be reduced, for example, from 256 to 17, and 14,739 (=17×17×17×3) data tables may be used to perform interpolation calculation to obtain a calculation result. Other than the 17 grids, a suitable number of grids, such as 16 grids, 9 grids, and 8 grids, may be set as appropriate. Any known method such as tetrahedral interpolation may be used. In the present exemplary embodiment, predefined 3D look-up tables are held in the ROM 203 or the like of the recording apparatus 20.

In step S706, the CPU 201 generates recording signal values for applying the colored liquids using the 3D look-up tables based on the color correction processed R′, G′, and B′ data. The recording signal value (C) defines an ink amount of cyan (C) to be applied to each pixel. Similarly, the recording signal value (M), the recording signal value (Y), and the recording signal value (K) respectively define an ink application amount of magenta (M), an ink application amount of yellow (Y), and an ink application amount of black (K). The recording signal values for the respective colors are each 8 bit information, and the value range of each of the recording signal values is 0 to 255. The value indicating the smallest application amount of the colored liquid is “0”, and the value indicating the largest application amount of the colored liquid is “255”. In the present exemplary embodiment, the conversion processing is performed as described below to obtain the recording signal values of the colored liquids using the 3D look-up tables. Equations 5 to 8 are a function 3D_LUT[R′][G′][B′][N] of the 3D look-up tables. The values of the R′G′B′ data are input in respective variables R′, G′, and B′, and any one of C, M, Y, and K to be output is designated in a valuable N. In the present exemplary embodiment, 0, 1, 2, and 3 are designated respectively as C, M, Y, and K.

$$C = 3 D\_LUT [ {R}^{′} ] [ {G}^{′} ] [ {B}^{′} ] [ 0 ] \qquad ( Equation 5 )$$

$$M = 3 D\_LUT [ {R}^{′} ] [ {G}^{′} ] [ {B}^{′} ] [ 1 ] \qquad ( Equation 6 )$$

$$Y = 3 D\_LUT [ {R}^{′} ] [ {G}^{′} ] [ {B}^{′} ] [ 2 ] \qquad ( Equation 7 )$$

$$K = 3 D\_LUT [ {R}^{′} ] [ {G}^{′} ] [ {B}^{′} ] [ 3 ] \qquad ( Equation 8 )$$

The above-described 3D look-up tables are held for each of the recording signal values (H) of the foaming acceleration liquid. In the conversion processing into the recording signal values of the colored liquids, the 3D look-up tables used for the conversion processing are selected for each pixel, based on the signal value of the recording signal value (H), and the information about the edge region and non-edge region stored in the RAM 202. As an example, in a case where the pixel values of a region 43 illustrated in FIG. 4B after the color correction are (R′, G′, B′)=(0, 255, 255), the signal values in the 3D look-up tables applied to the region 801 are (C, M, Y, K)=(C1, 0, 0, 0). Further, the signal values in the 3D look-up tables applied to the region 802 are (C, M, Y, K)=(C2, 0, 0, 0). The signal values in the 3D look-up tables applied to the region 803 are (C, M, Y, K)=(C3, 0, 0, 0).

The signal values in the 3D look-up tables applied to the region 804 are (C, M, Y, K)=(C4, 0, 0, 0). The signal values in the 3D look-up tables applied to the region 805 are (C, M, Y, K)=(C5, 0, 0, 0). In addition, a relationship C1<C3<C5 is satisfied. The recording signal value of each of the colored liquids is generated so that as the signal value of the recording signal value (H) of the foaming acceleration liquid is larger, i.e., the application amount of the foaming acceleration liquid is larger, the application amount of each of the colored liquids becomes larger. In addition, relationships C3<C2 and C5<C4 are satisfied. More specifically, in the region to which the foaming acceleration liquid is applied, the application amounts of the colored liquids to the edge region are controlled to be larger than those to the internal region (non-edge region), which is not the edge region. In the present example, only the application amount of the cyan (C) is adjusted, but by also adjusting the application amounts of the black (K), magenta (M), and yellow (Y) inks, the density adjustment can be controlled in minute detail. In a case of secondary colors formed using a plurality of kinds of inks, the total amount of the application amounts of the colored liquids for each pixel may be increased as the recording signal value (H) of the foaming control liquid is increased.

When the above-described 3D look-up tables are used, the data amounts of the look-up tables may be reduced. For example, the 3D look-up tables are prepared for two cases where the signal values of the recording signal values (H) of the foaming acceleration liquid are “0” and “255”. Then, in a case where the recording signal value (H) of the foaming acceleration liquid is a value from 1 to 254, the 3D look-up table for each of the recording signal values (H) may be calculated by performing the interpolation calculation using the 3D look-up tables of “0” and “255”. In the present exemplary embodiment, predefined 3D look-up tables are held in the ROM 203 or the like of the recording apparatus 20.

In step S707, the CPU 201 performs quantization processing based on the recording signal value (H) of the foaming acceleration liquid, the recording signal value (K), the recording signal value (C), the recording signal value (M), and the recording signal value (Y) of the colored liquids. For the quantization processing, various quantization levels, such as binarization, ternarization, and 16 valued, can be used. In general, in a case where binarization processing is performed, the recording signal value (K), the recording signal value (C), the recording signal value (M), and the recording signal value (Y) are respectively converted into 1 bit data of black (K), of cyan (C), of magenta (M), and of yellow (Y). This 1 bit data indicates whether to apply a droplet of the colored liquid, i.e., whether to form a dot of the colored liquid on the recording medium 10. As a quantization processing method, a known pseudo-halftone processing method, such as a dither matrix method and an error diffusion method, is used.

In step S708, the quantized data is transferred to the head controller 205. Then, based on the quantized data, the colored liquids of respective colors are discharged from the recording elements 31, and applied to the recording medium 10. After the colored liquids are applied to the recording medium 10 to record an image, the quantized data is stored in the RAM 202 for a predetermined time.

In step S709, the CPU 201 determines whether recording of the image for the page is completed. In a case where the recording is completed (YES in step S709), the present processing in the flowchart is ended, and the processing proceeds to processing of the next page, or to step S616 in FIG. 6.

In a case where the recording is not completed (NO in step S709), the processing returns to step S701 to continue the processing on the same page.

As described with reference to FIGS. 7, 8A, and 8B, the present exemplary embodiment controls the application amounts of the colored liquids depending on the application amount of the foaming acceleration liquid. As the application amount of the foaming acceleration liquid is larger, i.e., the degree of foaming of the foaming particles 13 is larger, the change of the surface area and the height of the convex structure caused by the foaming are larger. Accordingly, the density of a region with a high degree of foaming may visually recognized as having a low density, even if the same amounts of the colored liquids are applied. As a result, even if the color indicated by the colored liquid plate is the same, the application amounts of the colored liquids are determined so that the colored liquids are applied more to the region of which the degree of foaming is higher. In this way, it is possible to prevent the color difference in the recording product caused by the degree of foaming.

In the above-described exemplary embodiment, the description is given of the example in which the foaming particles 13 in the region to which the foaming acceleration liquid is applied foam by being heated, and the foaming particles 13 in the region to which the foaming acceleration liquid is not applied do not foam even by being heated. However, the present exemplary embodiment is not limited to this example, and a foaming suppression liquid may be used. The degree of foaming in a region to which a large amount of the foaming suppression liquid is applied is small, and the degree of foaming in a region to which a small amount of the foaming suppression liquid is applied is large. As described above, to reduce the color difference between the foaming region and non-foaming region, the application amounts of the colored inks to the foaming region just need to be larger than those to the non-foaming region. Thus, the application amounts of the colored liquids to the region to which the small amount of the foaming suppression liquid is applied just need to be larger than those to the region to which the large amount of the foaming suppression liquid is applied. Depending on the function of the foaming suppression liquid, since there may be a case where the region to which the foaming suppression liquid is applied does not foam at all even by being heated, or a case where the degree of foaming may change depending on the amount of the foaming suppression liquid, the application amounts of the colored liquids may be changed in a step-by-step manner depending on the function of the foaming control liquid.

In the first exemplary embodiment, the description is given of the example in which the 3D look-up tables to be applied when the recording signal values of the colored liquids are generated are selected and applied, depending on the recording signal value (H) of the foaming acceleration liquid. In a second exemplary embodiment, one type of 3D look-up tables is applied when the recording signal values of the colored liquids are converted.

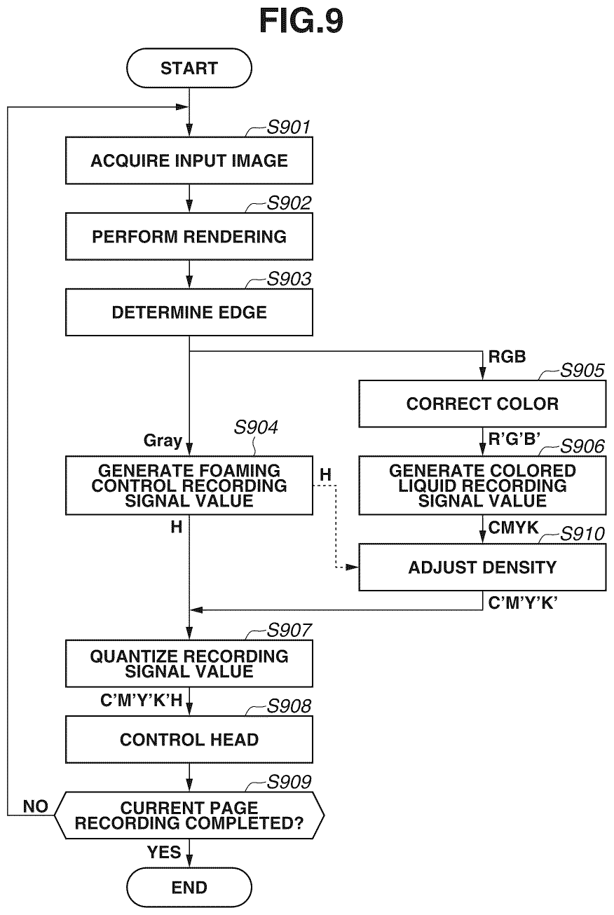

FIG. 9 is a flowchart illustrating a procedure of processing according to the present exemplary embodiment. In the present exemplary embodiment, an example is given in which the recording signal value (K), the recording signal value (C), the recording signal value (M), and the recording signal value (Y) are adjusted depending on the recording signal value (H) of the foaming control liquid. Processing in steps S901 to S905, and S907 to S909 illustrated in FIG. 9 is similar to that in steps S701 to S705, and S707 to S709 illustrated in FIG. 7 according to the first exemplary embodiment.

In step S906, 3D look-up tables are applied. In the present exemplary embodiment, only one type of the 3D look-up tables is prepared regardless of the recording signal value (H) of the foaming control liquid. The conversion processing of the recording signal values of the colored liquids is similar to that performed in step S706.

In step S910, the CPU 201 performs a density adjustment on the converted recording signal value data of the colored liquids. For the density adjustment, two-dimensional (2D) look-up tables are used.

Equations 9 to 12 below are lookup table functions 2D_LUT_C[H][C], 2D_LUT_M[H][M], 2D_LUT_Y[H][Y] and 2D_LUT_K[H][K] for cyan (C), magenta (M), yellow (Y) and black (K), respectively. In the function 2D_LUT_C[H][C], data values of variables H and C are input. In a similar manner, the density adjustment is performed for each of M, Y, and K using the 2D look-up tables.

$${C}^{′} = 2 D\_LUT \_C [ H ] [ C ] \qquad ( Equation 9 )$$

$${M}^{′} = 2 D\_LUT \_M [ H ] [ M ] \qquad ( Equation 10 )$$

$${Y}^{′} = 2 D\_LUT \_Y [ H ] [ Y ] \qquad ( Equation 11 )$$

$${K}^{′} = 2 D\_LUT \_K [ H ] [ K ] \qquad ( Equation 12 )$$

The above-described 2D_LUT consists of 65,536 (=256×256) data tables. In order to reduce the data amounts of the look-up tables, the number of grids may be reduced, for example, from 256 to 17, and 289 (=17×17) data tables are used to perform interpolation calculation to obtain a calculation result. Other than the 17 grids, a suitable number of grids, such as 16, 9, and 8 grids, may be set as appropriate. Any known method, such as a 2D linear interpolation, may be used. In the present exemplary embodiment, the 2D look-up tables are determined in advance for each of the edge region and the non-edge region, and stored in the ROM 203 or the like of the recording apparatus 20.

Next, a total application amount (SUM) for each pixel is calculated by adding values of (C′, M′, Y′, K′) obtained by using the 2D look-up tables. Then, the CPU 201 determines for each pixel whether the total application amount (SUM) is equal to or less than the maximum application value (TH) for the recording medium 10. In a case where the total application amount (SUM) is equal to or less than the maximum application amount (TH) for the recording medium 10 for all the pixels, the CPU 201 determines the (C′, M′, Y′, K′) to be signal values after the density adjustment. In a case where one or more pixels, of which the total application amounts (SUM) exceed the maximum application amount (TH) for the recording medium 10, are included, Equations 13 to 17 shown below are used. The CPU 201 calculates a ratio R from a total application amount (SUM_MAX) of a pixel with the largest total application amount and the maximum application amount (TH), and adjusts the C′, M′, Y′, and K′ based on the calculated ratio R.

$$R = TH / SUM\_MAX \qquad ( Equation 13 )$$

$${C}^{′} = {C}^{′} \times R \qquad ( Equation 14 )$$

$${M}^{′} = {M}^{′} \times R \qquad ( Equation 15 )$$

$${Y}^{′} = {Y}^{′} \times R \qquad ( Equation 16 )$$

$${K}^{′} = {K}^{′} \times R \qquad ( Equation 17 )$$

The (C′, M′, Y′, K′) calculated using the above-described Equations 13 to 17 are determined to be signal values after the density adjustment.

As described with reference to FIG. 9, in the present exemplary embodiment, the CPU 201 calculates a total value of the application amounts of the plurality of colored liquids different in color based on the application amount of the foaming acceleration liquid (H), and corrects the application amount of each of the colored liquids based on the total value and the maximum application amount. In this way, the amounts of the colored liquids are corrected depending on the application amount of the foaming acceleration liquid, and the color difference in the recording product caused by the degree of foaming can be prevented.

### Other Exemplary Embodiments

In the above-described exemplary embodiments, the description is given of the example in which the foaming control liquid is applied using the inkjet recording head, but the method is not limited to the inkjet recording head as long as a method can apply a component capable of controlling the degree of foaming. A method of applying the foaming control liquid on the recording medium using a roller, or another application method, such as an electrophotographic method, may be employed. In addition, the method of controlling the degree of the foaming may be a method of not only applying the foaming control liquid to the recording medium containing the foaming particles 13 but also applying the foaming particles 13 to the recording medium.

Further, in the above-described exemplary embodiments, the description is given of the example in which the foaming particles 13 are caused to foam when heated, but the method of causing the foaming particles 13 to foam is not limited to the heating method. It is not limited to the method of causing the foaming particles 13 to foam by thermal energy, and the present disclosure can be applied to a case where the foaming particles 13 are caused to foam by application of some kind of energy, for example by irradiation of light with a predetermined wavelength. Further, in the above-described exemplary embodiments, the description is given of the example in which the foaming acceleration liquid for controlling the degree of foaming has the function of lowering the temperature where the foaming particles 13 start to foam, but the function of the foaming acceleration liquid is not limited thereto. The foaming acceleration liquid may have a function of causing the foaming particles 13 to easily foam by application of the foaming acceleration liquid in a case where the same energy is applied, or a function of increasing the number of forming particles that actually foam.

According to an aspect of the present disclosure, it is possible to prevent a color difference caused by the degree of foaming, in the case where of forming a recording product including a convex structure formed by causing foaming particles to foam.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-109639, filed Jul. 3, 2023, which is hereby incorporated by reference herein in its entirety.

What is claimed is:

1. A recording apparatus comprising:
one or more memories storing instructions; and
one or more processors that, upon execution of the stored instructions, are configured to:
apply a foaming control liquid for controlling a foaming degree of a foaming particle and a colored liquid containing a color material onto a recording medium in which a foam layer containing the foaming particle that foams by application of energy is provided on a base material;
generate a recording signal value for the colored liquid indicating an amount of the colored liquid to be applied onto the recording medium based on data of the colored liquid, and a recording signal value of the foaming control liquid indicating an amount of the foaming control liquid to be applied onto the recording medium based on data of the foaming control liquid; and
control an application operation of the application unit based on the generated recording signal value of the colored liquid and the recording signal value of the foaming control liquid,
wherein, in a case where the data of the colored liquid indicates that a color of a first region and a color of a second region are a same color, and where the data of the foaming control liquid indicates a degree of causing the first region to foam is larger than a degree of causing the second region to foam, the recording signal value of the colored liquid are generated so that an application amount of the colored liquid on the first region is larger than an application amount of the colored liquid on the second region.

2. The recording apparatus according to claim 1,
wherein the foaming particle are caused to foam by thermal energy, and
wherein the foaming control liquid lowers a temperature where the foaming particle starts to foam.

3. The recording apparatus according to claim 1, wherein the foaming control liquid is a foaming acceleration liquid that accelerates foaming of the foaming particle.

4. The recording apparatus according to claim 3, wherein, in the data of the foaming control liquid, an application amount of the foaming acceleration liquid on the first region is larger than that on the second region.

5. The recording apparatus according to claim 1, wherein the one or more memories store a plurality of pieces of conversion data for generating the recording signal value of the colored liquid from the data of the colored liquid,
wherein the recording signal value of the colored liquid are generated using any one of the plurality of pieces of conversion data based on the data of the foaming control liquid.

6. The recording apparatus according to claim 1, wherein the recording signal value of the colored liquid are generated so as not to exceed a predetermined maximum application amount.

7. The recording apparatus according to claim 1,
wherein, in the data of the foaming control liquid, a pixel, as an edge region, which is an outermost pixel in a region to which the foaming control liquid is to be applied and to which the colored liquid is to be applied, is detected and a region that is not the edge region in the region to which the foaming control liquid is to be applied, as a non-edge region, is detected, and the recording signal value of the colored liquid is generated so that an application amount of the colored liquid on the edge region is larger than that on the non-edge region.

8. The recording apparatus according to claim 2, wherein the foaming particle is a thermally expandable micro capsule including a shell layer containing thermoplastic resin and a volatile material enclosed in the shell layer.

9. The recording apparatus according to claim 1, wherein the foaming control liquid is a foaming suppression liquid that suppresses foaming of the foaming particle.

10. A recording method comprising:
applying a colored liquid of an amount based on data of the colored liquid, wherein the colored liquid contains a colored material to a recording medium in which a foam layer containing a foaming particle that foams by application of energy is provided on a substrate; and
applying a foaming control liquid of an amount based on data of the foaming control liquid, wherein the foaming control liquid for controlling a degree of foaming of the foaming particle and the colored liquid,
wherein, in a case where the data of the colored liquid indicates that a color of a first region and a color of a second region are same, and a degree of causing a first region to foam is larger than a degree of causing a second region to foam in the data of the foaming control liquid, the colored liquid is applied so that an amount of the colored liquid applied to the first region is larger than an amount of the colored liquid applied to the second region.
